(19) United States
(12) Patent Application Publication
(10) Pub. No.: US 2024/0420374 A1
(43) Pub. Date: Dec. 19, 2024

(54) METHOD FOR CONFIGURING OBJECT-BASED MULTIMEDIA FOR SHORT-FORM CONTENT AND DEVICE USING SAME

(71) Applicant: INDUSTRY-ACADEMIC COOPERATION GROUP OF SEJONG UNIVERSITY, Seoul (KR)

(72) Inventors: Oh Jin KWON, Hanam si (KR); Seung Cheol CHOI, Incheon (KR)

(21) Appl. No.: 18/705,916

(22) PCT Filed: Oct. 4, 2022
(86) PCT No.: PCT/KR2022/014902

§ 371 Date: Apr. 29, 2024

(30) Foreign Application Priority Data
Oct. 28, 2021 (KR) 10-2021-0145471

(51) Int. Cl. G06T 9/00; G06T 11/00

(52) U.S. Cl. CPC G06T 9/00; G06T 11/00

(57) ABSTRACT

Disclosed are a method for configuring object-based multimedia for short-form content composed of various media such as images or text, and a device using same. The method for configuring object-based multimedia comprises the steps of: designating a first object structure format (OSF) and a first object configuration format (OCF) of first media data; designating a second OSF and a second OCF of second media data; and defining a metadata model composed of an OSF including the first OSF and the second OSF and an OCF including the first OCF and the second OCF, wherein the OSF defines the size, shape, operation, appearance, or a selective combination thereof of each of objects including first media and second media, and the OCF defines the playback times of the objects constituting a representation, and the position and time relationships between the objects.

### CROSS-REFERENCE TO RELATED APPLICATIONS

This application claims the benefit under 35 U.S.C. section 371, of PCT International Application No. PCT/KR2022/014902, filed on Oct. 4, 2022, which claims foreign priority to Korean Patent Application No. 10-2021-0145471, filed on Oct. 28, 2021, in the Korean Intellectual Property Office, both of which are hereby incorporated by reference in their entireties.

### TECHNICAL FIELD

The present disclosure relates to an object-based multimedia composition method and, more particularly, to an object-based multimedia composition method for a short-form content including a plurality of media elements such as images and text, and a device using the method.

### BACKGROUND ART

Joint Photographic Experts Group (JPEG) is a kind of lossy compression method and standard for digital still images. JPEG Snack specified in Part 8 of the JPEG standard, i.e., ISO/IEC 19566-8 standard, defines metadata which may enrich a presentation of media contents to facilitate sharing, editing, and presentation of the contents based on images compressed according to the JPEG standard. The JPEG Snack is a means to convey relatively simple multimedia experiences which is fundamentally based on images and the image file format.

Recently, lots of users are using various social communities and social services allowing bidirectional information transfer online, e.g., on the Internet. In particular, the number of the social service users uploading still pictures or videos in the form of short-form contents through their mobile devices or personal computers to share with other users has increased rapidly. The term “short-form content” used herein refers to a sequence of pictures or a video content that may be reproduced in a short duration, e.g., in an average of 15-60 seconds and a maximum of 10 minutes, and may also be referred to as “short video.”

In such an environment, there is a demand for a technical scheme allowing a selective activation of the short-form content including a plurality of pictures or facilitating a creation of the short-form content by converting a plurality of pictures into a video, for example. As an example of a scheme to meet the needs, Google Photos (a trademark of Alphabet Inc.) service may automatically convert plain pictures acquired in a same place and for a same person as each other into a cinematic videos for users.

However, existing technologies such as the Google Photos may have technical limitations in that the conversion of pictures into the video may deteriorate an image quality caused in the conversion and that the converted video is difficult to re-edit. In order to re-edit the converted video, the user may have to use a separate computer program additionally, which may make the re-editing process cumbersome and complicated.

Therefore, there is a need for a technical solution for facilitating a production or a use of a content such as the short-form content, and a demand for a method of providing a social networking service enabling the production of the content or effectively providing the social networking services.

### DISCLOSURE OF INVENTION

### Technical Problem

Provided is an object-based multimedia composition method and device facilitating a creation of a short-form content in a user terminal such as a mobile terminal or a personal computer.

Provided is an object-based multimedia composition method and device applicable to a short-form content providing service based on a plurality of pictures to create a multimedia content while maintaining the original pictures without converting the plurality of pictures into a video to prevent an image quality degradation.

Provided is an object-based multimedia composition method and device allowing to modify or re-edit a short-form content created before and enabling an existing decoder to decode the re-editable short-form content.

### Technical Solution

According to an aspect of an exemplary embodiment, an object-based multimedia composition method performed by a processor includes: specifying a first object-structured format and a first object-composition format of first media data; specifying a second object-structured format and a second object-composition format of second media data; and determining a metadata model comprising an object-structured format including the first object-structured format and the second object-structured format and an object-composition format including the first object-composition and the second object-composition. The object-structured format defines a size, a shape, a movement, an appearance, or a selective combinations thereof of each object including the first media and the second media. The object-composition format defines appearance or disappearance times of objects composing a representation and temporal and spatial relationships between the objects.

The object-based multimedia composition method may further include: organizing each object in the metadata model and constituting at least one JPEG Snack file in a predefined container to save structured data as at least one JPEG image file.

The metadata model may be a hierarchical model containing a plurality of object metadata and composition metadata corresponding to the object-composition format and aligned with the plurality of object metadata. The object metadata corresponding to the object-structured format may contain properties comprising position, time, and transition which compose the objects into the representation of a JPEG Snack format. Each of the objects may be rendered individually in a logical timeline of a JPEG Snack decoder.

The object metadata may include an ID attribute and a Type attribute and specifies behaviors of the objects in the representation constituting a JPEG Snack content. The ID attribute may be an identifier of the object in the representation, and the Type attribute may be set to enable a decoder to recognize properties of the object proactively.

When the Type attribute is set to indicate an object for a transition between two images, an object compositor controlling a decoding process may use only a transition property of the object metadata.

The composition metadata may allow a display of the objects composing the JPEG Snack representation to be adjusted and may enable the objects to be aligned in layer, position, or time based on respective object IDs. The position property may determine a position of an object designated by an object ID. When a plurality of objects overlap in the representation, a layer property may specify whether a particular object is positioned in front of or behind remaining objects.

The object-based multimedia composition method may further include: combining, by the JPEG Snack decoder, time information of all objects in the media data to construct a timeline for reproducing a JPEG Snack content. The objects may exist in the representation using their position and time property information.

According to an aspect of another exemplary embodiment, an object-based multimedia composition method performed by a processor includes: preparing a default image by decoding a JPEG image; composing a JPEG Snack representation with a plurality of objects using the default image as a background; and processing each object to be displayed on a screen at a designated time, at a designated location, and in a designated form based on composition information of each object included in a JPEG Snack content; wherein the composition information comprises a metadata model comprising an object-structured format including a first object-structured format and a second object-structured format and an object-composition format including a first object-composition and a second object-composition. The first object-structured format and the first object-composition format defines first media data, and the second object-structured format and the second object-composition format defines second media data.

According to another aspect of an exemplary embodiment, an object-based multimedia composition device includes: a JUMBF parser configured to receive metadata of a JPEG codestream and compose a JPEG Snack representation including an object-structured format and an object-composition format of media data in the JPEG codestream; a media decoder configured to receive the media data in the JPEG codestream, decode the media data to acquire media content and enable a compositor to render the media content; and an object composer configured to receive the JPEG Snack representation from the JUMBF parser, provide media format information and time information to the media decoder based on the JPEG Snack representation, and control a decoding operation of the media decoder and an output operation of the compositor such that the media content is output through a display device according to a predetermined time and location for the media content. The metadata of the media content includes an object-structured format and an object-composition format to enable a composition of the media content regardless of types of individual media contained in the media content.

The object-structured format may include a first object-structured format specifying a size, a shape, a movement, an appearance, or a selective combinations thereof of a first object in the JPEG codestream and a second object-structured format specifying a size, a shape, a movement, an appearance, or a selective combinations thereof of a second object in the JPEG codestream.

The object-composition format may include a first object-composition format specifying an appearance or disappearance time of a first object and temporal and spatial relationships between the objects and a second object-composition format specifying an appearance or disappearance time of a second object and temporal and spatial relationships between the objects.

The object-based multimedia composition device may further include a timeline constructor configured to combine time information of all objects in the media data to construct a timeline for reproducing a JPEG Snack content, or a processor configured to implement the timeline constructor. The objects may exist in the representation using their position and time property information.

### Advantageous Effects

The present disclosure provides an object-based multimedia composition method and device facilitating the creation of the short-form content in the user terminal such as a mobile terminal or a personal computer. According to the present disclosure, a user providing a short-form content providing service based on a plurality of pictures as in TikTok and Google Photos can create a multimedia content based on the plurality of pictures while maintaining the original pictures without converting the pictures into a video to prevent an image quality degradation.

The present disclosure allows to modify or re-edit a short-form content created before in technical fields such as content creation, content providing services, and social networking services and enables an existing decoder to decode the JPEG Snack content effectively in a conventional manner.

### DESCRIPTION OF DRAWINGS

FIG. 1 is a flowchart showing an object-based multimedia composition method for a short-form content (hereinbelow, abbreviated as “multimedia composition method”) according to an exemplary embodiment of the present disclosure;

FIG. 2 is a block diagram showing a hierarchical structure of a JPEG Snack format for a short-form content which may be applicable to the multimedia composition method of FIG. 1;

FIG. 3 is a block diagram of a JPEG Snack decoder suitable for implementing the multimedia composition method of FIG. 1;

FIG. 4 illustrates an example of a high-level metadata model of JPEG Snack which may be used in the multimedia composition method of FIG. 1;

FIG. 5 illustrates an exemplary structure of a JPEG file which may be used in the multimedia composition method of FIG. 1;

FIG. 6 illustrates an exemplary structure of a JUMBF content box for JPEG Snack, among JUMBF boxes for different content types, which may be used in the multimedia composition method of FIG. 1;

FIG. 7 illustrates an example of an organization of contents of a JPEG Snack description box among the JUMBF boxes for different content types which may be used in the multimedia composition method of FIG. 1;

FIG. 8 illustrates an example of an organization of contents of an instruction set box which may be used in the multimedia composition method of FIG. 1;

FIG. 9 illustrates an example of an organization of contents of an object metadata box among the JUMBF content types for the JPEG Snack which may be used in the multimedia composition method of FIG. 1;

FIGS. 10 and 11 illustrate exemplary representations for explaining the object-composition format and the object-structured format, respectively, which may be used in the multimedia composition method of FIG. 1;

FIG. 12 illustrates an example of an object's movement for explaining the motion property in the object-structured format which may be used in the multimedia composition method of FIG. 1;

FIG. 13 illustrates an example of a JPEG Snack timeline corresponding to the examples of FIGS. 10 and 11, which may be used in the multimedia composition method of FIG. 1;

FIG. 14 is a block diagram of an object-based multimedia composition device for a short-form content (abbreviated as “multimedia composition device”) according to an exemplary embodiment of the present disclosure;

FIG. 15 is a flowchart illustrating a multimedia composition method that may be performed by the multimedia composition device of FIG. 14;

FIG. 16 illustrates an example of a multimedia content that may be produced by the multimedia composition device of FIG. 14;

FIG. 17 illustrates another example of a multimedia content that may be produced by the multimedia composition device of FIG. 14; and

FIG. 18 illustrates another example of a multimedia content that may be produced by the multimedia composition device of FIG. 14.

### BEST MODE

For a clearer understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

In the description of exemplary embodiments of the present disclosure, “at least one of A and B” may mean “at least one of A or B” or “at least one of combinations of one or more of A and B”. In addition, in the description of exemplary embodiments of the present disclosure, “one or more of A and B” may mean “one or more of A or B” or “one or more of combinations of one or more of A and B”.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanying drawings. In order to facilitate general understanding in describing the present disclosure, the same components in the drawings are denoted with the same reference signs, and repeated description thereof will be omitted.

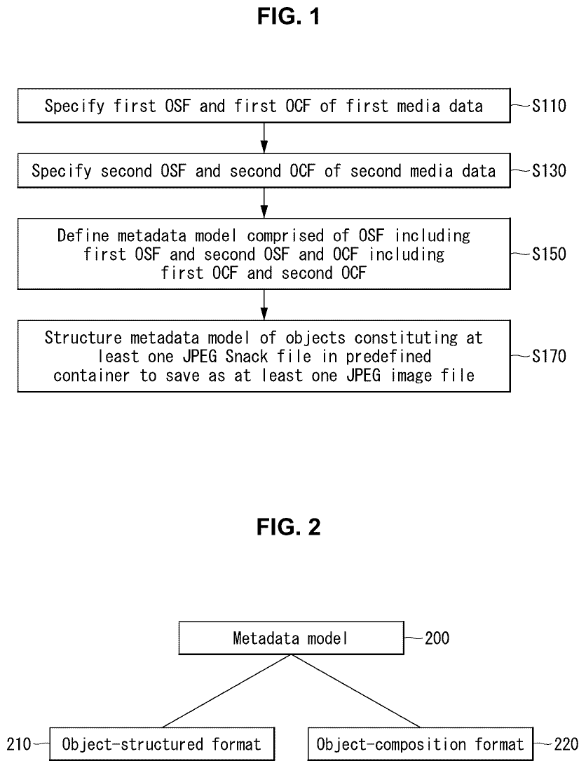

FIG. 1 is a flowchart showing an object-based multimedia composition method for a short-form content (hereinbelow, abbreviated as “multimedia composition method”) according to an exemplary embodiment of the present disclosure.

Referring to FIG. 1, the multimedia composition method is based on a media format defined to allow an effective re-editing of the short-form content comprised of a plurality of media elements such as images, text, and so on. Each of the images, text, etc. may define and be referred to as an object. Meanwhile, the multimedia composition method may be performed by a processor or a computing device equipped with a processor.

Specifically, the object-based multimedia composition method may include operations of specifying a first object-structured format (OSF) and a first object-composition format (OCF) of first media data (S110); specifying a second OSF and a second OCF of second media data (S130), defining a metadata model comprised of an object-structured format including the first OSF and the second OSF and an object-composition format including the first OCF and the second OCF (S150); and organizing each object in the metadata model and constituting at least one JPEG Snack file in a predefined container to save structured data as at least one JPEG image file (S170).

The object-structured format (OSF) may define a size, a shape, a movement, an appearance, or a selective combination thereof of each of objects including those associated with the first media data and second media data, and may also be referred to as an object structure format.

The object-composition format (OCF) may define appearance or disappearance times of objects composing a representation on a display device and temporal and spatial relationships between the objects, and may also be referred to as an object composition format.

The exemplary embodiment described above may enable to provide an environment for facilitating a production of the short-form contents in the fields of contents production, contents providing services, social networking, and so on. In particular, in short-form contents providing services based on multiple plain pictures, original media data may be maintained without being converted into a video, which allows to create, share, and modify or re-edit a high-quality content without any quality degradation. In addition, an existing decoder may be used to decode the content without additional means or configuration, which may provide an excellent compatibility to the decoder.

FIG. 2 is a block diagram showing a hierarchical structure of the Joint Photographic Experts Group (JPEG) Snack format for a short-form content which may be applicable to the multimedia composition method of FIG. 1.

Referring to FIG. 2, the JPEG Snack format may specify the metadata model 200 comprised of two formats. The metadata model 200 may have a hierarchical structure including the object-structured format 210 and the object-composition format 220.

The object-structured format (OSF) 210 may include attributes of each object such as a media type, the motion, the style, and the location of the object. That is, the object-structured format (OSF) 210 may define the appearance and behavior of an individual object. The object-structured format (OSF) 210 may include information about the size and opacity of the object, movement information in a certain timeline of representation, and information on a location of the media data such as an image codestream.

The object-composition format (OCF) 220 may include composition properties of the objects such as placements, times, and persistency of the objects pointed to by respective object IDs. That is, the object-composition format 220 may identify the objects constituting the representation and describe a creation and a destruction of each object. The object-composition format 220 may describe the temporal and spatial relationship between the objects by providing information on the time and position of the individual object to show, and the time and position of their disappearance. Each object has independent position information on a decoder screen. The composition information may determine a z-order of the objects displayed to the user.

The z-order may refer to an ordering of overlapping two-dimensional objects such as overlapping windows in a window manager, shapes in a vector graphics editor, and objects in a three-dimensional application, for example.

Thus, the JPEG Snack is fundamentally a means for delivering relatively simple multimedia experiences based on the images and image file formats, and may define the metadata that may enhance a versatility of the presentation of the media contents to facilitate the sharing, editing, and presentation of the contents. In addition, the two formats in the metadata may enable to modify or re-edit the JPEG Snack content prepared previously.

The JPEG Snack format can provide information that allows a JPEG Snack application to share and render the media content by accessing objects in the JPEG Snack file or referencing objects contained in other files. Not all objects are necessarily contained in the same file. Each object contained in the JPEG Snack file may be organized using a predefined box and stored in the JPEG Snack file.

According to the present embodiment, when the decoder synchronizes the multiple media and constructs the JPEG Snack content, the decoder can easily modify or re-edit the JPEG Snack content through the operation of the metadata specified according to the metadata model 200 including the two formats within the JPEG Snack format.

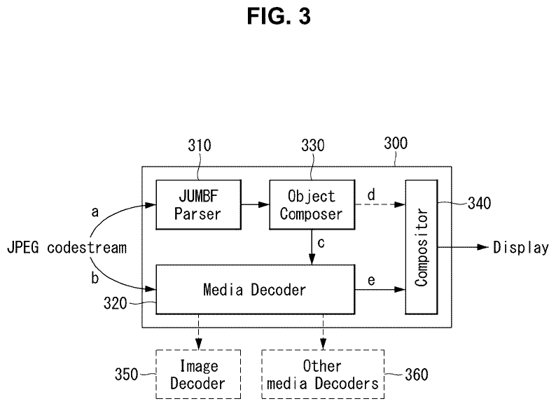

FIG. 3 is a block diagram of a system decoder for JPEG Snack suitable for implementing the multimedia composition method of FIG. 1.

Referring to FIG. 3, the system decoder for JPEG Snack (hereinbelow, also referred to as “JPEG Snack decoder” or “decoder”) 300 may implement the metadata model described above. The decoder 300 may include three conceptual necessary components: a default image, a timeline, and a layer and position. The decoder 300 may decode a JPEG image to prepare the default image and compose a JPEG Snack representation with several objects that use the default image as a background. Since the JPEG Snack may be created by defining when, where and how objects are composed, the decoder 300 may handle the timeline, the layer, and the position.

The JPEG Snack format may contain hierarchical metadata including the object-structured format (OSF) and the object-composition format (OCF). The metadata may include the first object-structured format and the first object-composition format representing the first media data, and the second object-structured format and the second object-composition format describing the second media data.

The decoder 300 may include a JPEG universal metadata box format (JUMBF) parser 310, a media decoder 320, an object composer 330, and a compositor 340.

In the decoder 300, the object composer 330 may receive a JPEG codestream containing the metadata (a) and the media data (b) through the JUMBF parser 310, invoke the media decoder 320 to decode the media data (b) from JPEG codestream, and render a decoded media content (e) to a display device through the compositor 340. The object composer 330 may provide the media decoder 320 with a media format and time as indicated by an arrow (c) in FIG. 3 and provide the position and the z-order to the compositor 340 as indicated by an arrow (d) in FIG. 3. The object composer 330 may control the media decoder 320 and the compositor 340 to decode and display the media content according to the time and the position information.

The JPEG Snack content may include a plurality of media contents such as an image, a caption, an image sequence, an audio clip, and a video clip, and the JPEG Snack representation may be composed to include the plurality of media contents.

The media decoder 320 may be configured such that the image among the plurality of media contents is decoded by a separate image decoder 350 or the media contents other than the image is decoded by other media decoders 360.

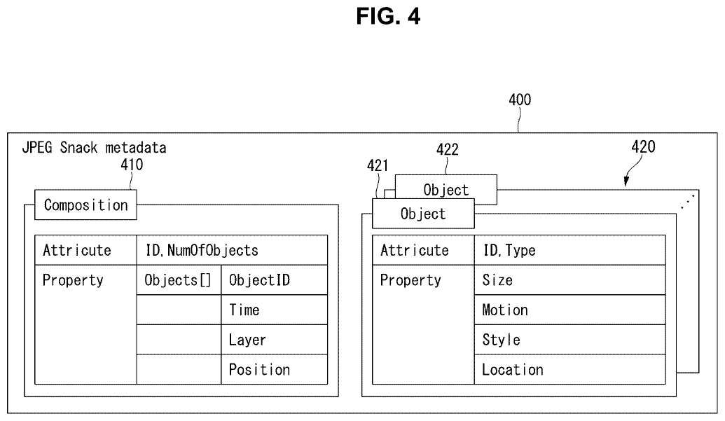

FIG. 4 illustrates an example of a high-level metadata model of JPEG Snack which may be used in the multimedia composition method of FIG. 1.

The JPEG Snack format may include the JPEG Snack metadata 400 to support the decoder playing back the JPEG Snack contents based on the JPEG Snack format. The JPEG Snack metadata 400 may be simply referred to as the “metadata.”

The metadata 400 may be a hierarchical model containing composition metadata corresponding to the object-composition format and a plurality of object metadata 421 and 422 aligned with the composition metadata. Each of the plurality of object metadata be simply referred to as the “object metadata 420.”

The object metadata 420 may include attributes of each object such as Type, Motion, Style, and Location attributes. According to the object metadata 420, each object may be rendered individually in a timeline of the decoder to support re-editing of the object. Re-editing of objects may include, for example, choosing a specific object and hiding the chosen object in the JPEG Snack viewer.

The object metadata 420 specifies the behaviors of the individual objects in the representation to enable the composition of the JPEG Snack content. Among the attributes of the object metadata 420, an ID attribute is an identifier of the object in the representation, and the Type attribute allows the decoder to recognize properties of the object proactively. For example, in case that the Type attribute is set to indicate an object for a transition between two images, the object composer may use only the transition property while ignoring the Size attribute or the Location attribute of the object.

The composition metadata 410 coordinates the objects composing the JPEG Snack representation. The composition metadata 410 may have properties such as Time, Persistency, and Position. Within the composition metadata 410, the objects may be arranged with Layer (z-order), Position, and Time properties along with an identifier (“ObjectID”) property. The Position property may determine where the object pointed to by the ObjectID property is to be placed. When objects are overlapped according to the Position property, the Layer property may organize the objects so that a certain object may be placed in front or behind other objects.

JPEG Snack may have only one composition metadata consisting of one or more objects within the JPEG Snack file. The JPEG Snack decoder may combine the Time information of all objects to construct a timeline for a playback of the JPEG Snack content, and may function such that the objects exist individually in the representation by using the Size and Time attributes of each object.

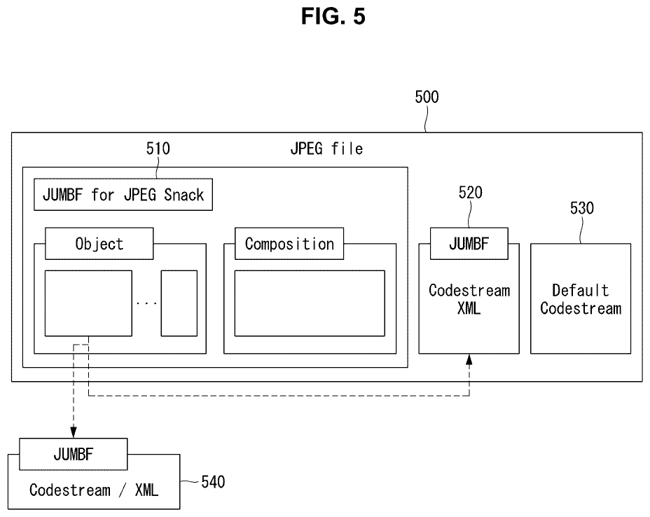

FIG. 5 illustrates an exemplary structure of a JPEG file which may be used in the multimedia composition method of FIG. 1.

Referring to FIG. 5, a JPEG file 500 may be formed as a series of boxes. That is, in the organization of the JPEG file 500, an object may be represented by a JUMBF box 510, 520, or 530. The JPEG file 500 includes a default codestream 530 and may also be referred to as a JPEG Snack file.

A first type of JUMBF boxes 510 for JPEG Snack, i.e., a first JUMBF boxes 510, may contain the object metadata and the composition metadata to compose the JPEG Snack representation. Another type of JUMBF boxes 520, i.e., a second JUMBF boxes 520, may be used to deliver the media content such as a codestream and XML document for each object. The object metadata may be contained on a plurality of JUMBF boxes in the same file.

In addition, the content types indicated by the object metadata may be different JUMBF boxes based on the object type. The JUMBF box for an object may be configured to refer to a JUMBF box 540 of media data contained in another file.

The JPEG Snack format provides information to define the metadata for composing the representation and the format in which the metadata is organized in the JPEG image files.

A conventional JPEG decoder may ignore the JUMBF boxes for the JPEG. For example, if the JPEC Snack metadata is embedded in the file of the JPEG-1, an extension of the JPEG Snack file may be ‘.jpg’ like a conventional JPEG-1 image, so that the conventional JPEG-1 decoder may decode only the default codestream. This feature may provide compatibility with existing JPEG image coding standards based on the box-based format.

In an example, the default codestream 530 may be placed at the end of the JPEG file to be compatible with the conventional JPEG image coding standards. For example, the JPEG-1 decoder may be configured to ignore any additional data beyond an edge-of-image (EOI) marker.

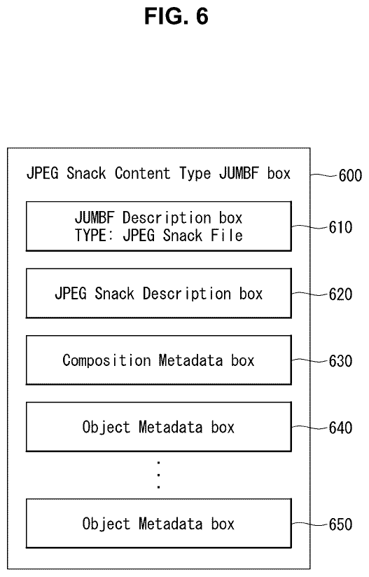

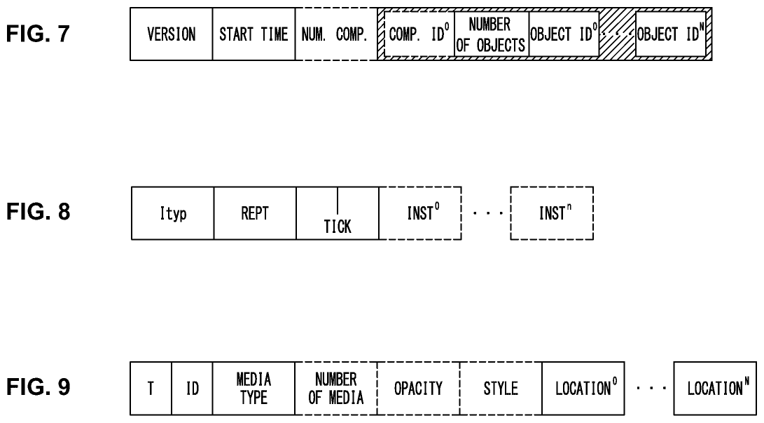

FIG. 6 illustrates an exemplary structure of a JUMBF content box for JPEG Snack, among JUMBF boxes for different content types, which may be used in the multimedia composition method of FIG. 1. FIG. 7 illustrates an example of an organization of contents of a JPEG Snack description box among the JUMBF boxes for different content types which may be used in the multimedia composition method of FIG. 1. FIG. 8 illustrates an example of an organization of contents of an instruction set box which may be used in the multimedia composition method of FIG. 1. FIG. 9 illustrates an example of an organization of contents of an object metadata box among the JUMBF content types for the JPEG Snack which may be used in the multimedia composition method of FIG. 1.

Referring to FIG. 6, a JUMBF box 600 may have a JPEG Snack content type with embedded JPEG Snack metadata, and may include a JUMBF description box 610, a JPEG Snack description box 620, an instruction set box 630, and one or more object metadata boxes 640 and 650.

The type of the JUMBF description box 610 may be a JPEG Snack file.

The JPEG Snack description box 620 may provide additional information such as a version of the format. The JPEG Snack description box 620 signals a plurality of objects constituting the JPEG Snack representation. The JPEG Snack description box 620 may include a plurality of fields including a version, a start time, and a number of objects. The version field may indicate whether the format supports media contents such as an image, a caption, a pointer, an image sequence, a video clip, and an audio clip. The start time field may signal a time to start rendering the composition, and the number of objects field may signal a number of Object Metadata boxes corresponding with the present JUMBF box.

The JUMBF content box for JPEG Snack may further include a plurality of composition metadata to provide different types of representation. The composition metadata may include the instruction set box 630. The instruction set box 630 signals information about the composition of the JPEG Snack representation.

As shown in FIG. 8, the instruction set box 630 may include fields of an instruction type (Ityp), a repetition (REPT), a duration of timer tick (TICK), and one or more instructions (INSTi).

The instruction type (Ityp) field may specify the type of the instructions and which instruction parameters can be found within this JUMBF box. This field may be encoded as a 16-bit flag. The meanings of the flag according to the values are shown in Table 1 below.

TABLE 1

| Value | Meaning |
|---|---|
| 0000 0000 0000 0000 | No instructions are present, and thus no |
| | instructions are defined for the objects in |
| | the file. |
| xxxx xxxx xxxx xxx1 | Each instruction contains XO and YO parameters. |
| xxxx xxxx xxxx xx1x | Each instruction contains the WIDTH and |
| | HEIGHT parameters. |
| xxxx xxxx xxxx x1xx | Each instruction contains the LIFE, NEXT-USE |
| | and PERSIST parameters. |
| xxxx xxxx xxx1 xxxx | Each instruction defines the crop parameters |
| | XC, YC, WC and HC. |

The repetition (REPT) field specifies a number of times to repeat a specific set of instructions after executing the instruction set. This field may be encoded as a 2-byte big-endian unsigned integer. For example, a value of 65,535 may indicate that the instruction will be repetitively executed indefinitely. The duration of timer tick (TICK) field may specify a duration of a timer tick defined in a LIFE field of instruction parameters in milliseconds. This field may be encoded as a 4-byte big-endian unsigned integer. If the instruction type (Ityp) field specifies that the LIFE field is not used, the duration of timer tick (TICK) field may be set to 0 so that the reader may ignore this field.

The instruction (INSTi) field may specify a series of instruction parameters for a single instruction. A plurality of instructions (INST⁰-INSTⁿ) in the instruction field can be referenced one-to-one in order with the plurality of object IDs in the JPEG Snack description box. The instruction field may include a first to N-th instructions. N may be an arbitrary natural number greater than 1.

Each individual instruction field may include fields of a horizontal offset (XO) field, a vertical offset (YO) field, a width of current layer (WIDTH), a height of current layer (HEIGHT) field, a persistence (PERSIST) field, a duration of current instruction (LIFE) field, a number of instructions before reuse (NEXT-USE) field, a horizontal crop offset (XC) field, a vertical crop offset (YC) field, a cropped width (WC) field, and a cropped height (HC) field.

In more detail, the horizontal offset (XO) field specifies a horizontal location at which the top left corner of the object activated by the current instruction is placed in a render area in samples. This field may be encoded as a 4-byte big-endian unsigned integer. If this field is absent, the default value of 0 may be used.

The vertical offset (YO) field specifies a vertical location at which the top left corner of the object activated by the current instruction is placed in the render area in samples. This field may be encoded as a 4-byte big-endian unsigned integer. If this field is absent, the default value of 0 may be used.

The width of current layer (WIDTH) field of the current composition layer specifies a width of a rendering area on the display scaled to render the current composition layer being activated by the current instruction. This field may be encoded as a 4-byte big-endian unsigned integer. If this field is missing, the width of the composition layer may be used.

The height of current layer (HEIGHT) field of the current composition layer specifies a height of the rendering area on the display scaled to render the current composition layer being activated by the current instruction. This field may be encoded as a 4-byte big-endian unsigned integer. If this field is missing, the height of the composition layer may be used.

The persistence (PERSIST) field specifies whether the object rendered on the display as a result of the execution of the current instruction may persist on the display background may be reset to a state before the execution of the present instruction. This field may be encoded as a 1-bit Boolean field. A value of 1 indicates that the current composition layer is persistent. If this field is absent, the persistence may be set to true.

The duration of current instruction (LIFE) field specifies a number of timer ticks that may ideally occur between the completion of execution of the current instruction and the completion of execution of the next instruction. A value of 0 indicates that the current instruction and the next instruction are executed within the same display update, which allows a single frame from the animation to be composed of updates to multiple composition layers. A value of 2³¹−1 may indicate an indefinite delay or pause for user interaction. This field may be encoded as a 31-bit big-endian unsigned integer. If this field is missing, the lifetime of the instruction may be set to 0.

The number of instructions before reuse (NEXT-USE) field specifies a number of instructions that must be executed before reusing the current composition layer. This field may be used to simply optimize a caching strategy in the application. A value of zero in this field, which results from a non-zero value in a LOOP parameter in a composition options box, implies that the current image should not be reused for any subsequent instructions even if a global loop is executed. The composition layer passed for reuse in this way may be the original composition layer before any cropping or scaling indicated by the current instruction is conducted. If this field is not present, the number of instructions may be set to 0, indicating that the current composition layer will not be reused. This field may be encoded as a 4-byte big-endian unsigned integer.

The horizontal crop offset (XC) field specifies a horizontal distance in samples to a left edge of a desired portion of the current composition layer. The desired portion may be cropped from the current composition layer and subsequently rendered by the current instruction. If this field is not present, the horizontal crop offset may be set to 0. This field may be encoded as a 4-byte big-endian unsigned integer.

The vertical crop offset (YC) field specifies a vertical distance in samples to a top edge of a desired portion of the current composition layer. The desired portion may be cropped from the current composition layer and subsequently rendered by the current instruction. If this field is not present, the horizontal crop offset may be set to 0. This field may be encoded as a 4-byte big-endian unsigned integer.

The cropped width (WC) field specifies a horizontal size in samples of the desired portion of the current composition layer. The desired portion may be cropped from the current composition layer and subsequently rendered by the current instruction. If this field is not present, the horizontal crop offset may be set to 0. This field may be encoded as a 4-byte big-endian unsigned integer.

The cropped height (HC) field specifies the vertical size of the desired partial sample of the current composition layer. The desired portion may be cropped from the current composition layer and subsequently rendered by the current instruction. If this field is not present, the horizontal crop offset may be set to 0. This field may be encoded as a 4-byte big-endian unsigned integer.

The object metadata box 640 may signal information about the media contents composing the JPEG Snack representation. The type of the object metadata box 640 may be ‘obmb’ (0x6f62 6d62). As shown in FIG. 9, the object metadata box 640 may include fields of a toggle (T) field, an ID field, a media type field, a number of media field, an opacity field, a style field, and one or more location fields.

The toggle field may indicate toggles which may have following values and meanings. Here, the toggle field may be referred to as a second toggle field, and the toggle may be referred to as a second toggle.

TABLE 2

| Binary value | Meaning | TOGGLE Details |
|---|---|---|
| 0000 0xx1 | Number of media present | This option signals if the |
| 0000 0xx0 | No number of media | NUMBER OF MEDIA field is |
| | present | present. |
| 0000 0x1x | Style present | This option signals if the |
| 0000 0x1x | No style present | STYLE field is present. |
| 0000 01xx | Opacity present | This option signals if the |
| 0000 00xx | No opacity present | OPACITY field is present. |

As shown in Table 2, the toggle field may contain toggles which mean “Number of media present”, “No number of media present”, “Style present”, “No style present”, “Opacity present”, or “No opacity present”. The value of each toggle may be set to an 8-bit bit sequence, in which case the first 5 bits may be reserved for later use. The remaining fields of the object metadata box 640 may have a fixed size of 8, 16, or 32 bits or a variable size, and may have a value of a type of an unsigned integer, a floating point value, a UTF-8 character string which is one of the variable-length character encoding scheme for Unicode, or null-terminated UTF-8 character string. The UTF-8 character string may have a size of 48 bits or 56 bits.

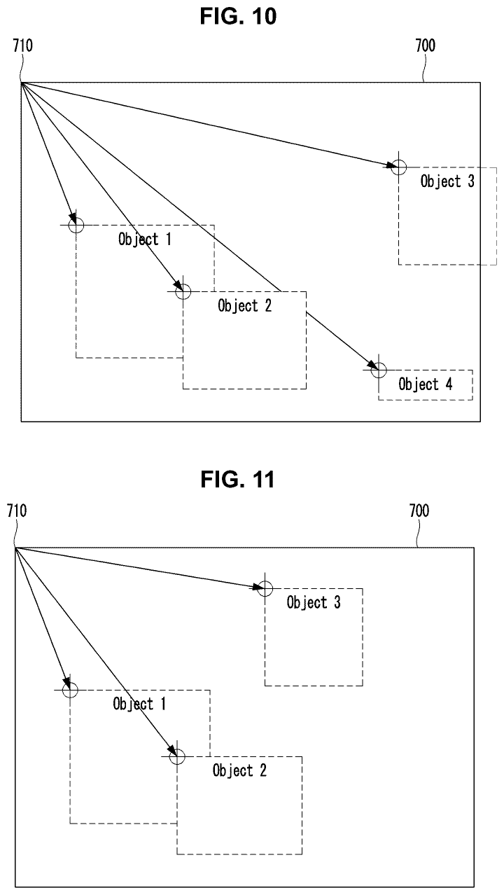

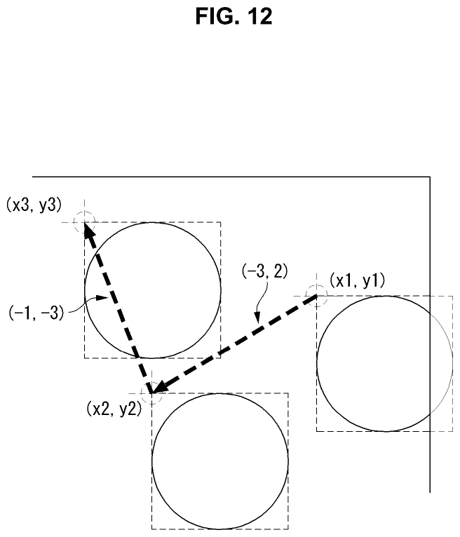

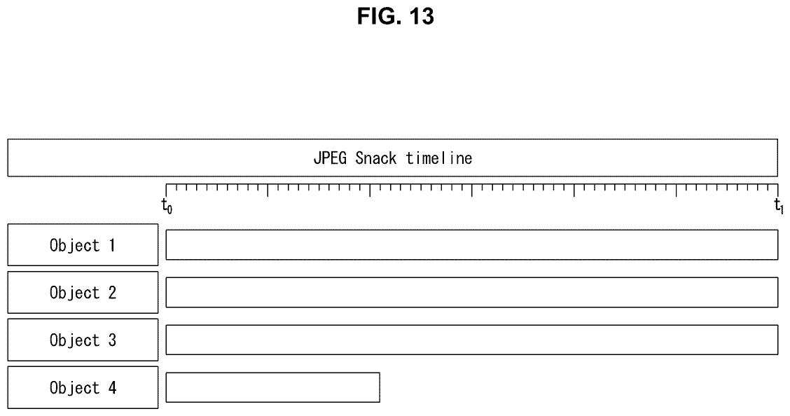

FIGS. 10 and 11 illustrate exemplary representations for explaining the object-composition format and the object-structured format, respectively, which may be used in the multimedia composition method of FIG. 1. FIG. 12 illustrates an example of an object's movement for explaining the motion property in the object-structured format which may be used in the multimedia composition method of FIG. 1. FIG. 13 illustrates an example of a JPEG Snack timeline corresponding to the examples of FIGS. 10 and 11, which may be used in the multimedia composition method of FIG. 1.

FIGS. 10 and 11 show the roles of the object-composition format and the object-structured format in composing the JPEG Snack representation. The object-composition format may provide the composition information to define when and where the objects, i.e., objects #1-#4, will appear and disappear in the representation to organize the objects. The object-structured format may signal information on the individual object's behavior and location of the resource.

The object composer of the multimedia composition device may manage instances of the objects, but the decoding of the individual objects is conducted independently by the media decoder. The object composer may inform the object compositor the z-order and movement information of the object. The object compositor may render the decoded media data according to the z-order and the position information.

Meanwhile, an invisible object such as an audio clip does not have the z-order and the position information. The audio clip may be considered to contain a spatial audio.

As shown in FIG. 10, the position at a first time (i.e., t=t₀) of each object having a width and a height may be determined by a location of the top-left corner of the object with respect to an origin 710 of the representation 700. Also, as shown in FIG. 11, the position of the object at a second time (i.e., t=t₁) may be determined by the location of the top-left corner of the object with respect to the origin 710 of the representation 700.

As can be seen in FIGS. 10 and 11, the object #2 is above the object #1, and the object #1 is partially occluded by the object $2 at the first time (i.e., t=t₀). In addition, the object #3 has an occluded region beyond the representation 700. The object composer according to the present embodiment may handle these regions smoothly with reference to the object-composition format and the object-structured format. In the case of the object #4, its duration of existence is shorter than the JPEG Snack's total duration, and the object disappears at the second time (i.e., t=t₁) as shown in FIG. 11. A timeline summarizing the duration of the objects illustrated in FIGS. 10 and 11 is shown in FIG. 13.

Referring again to FIGS. 10 and 11, the object #3 moves to another position between the first time and the second time. The movements of object #3 indicated by dashed lines V1 and V2 in FIG. 12 may be described by the instruction set box.

In FIG. 12, it is assumed that the object #3 is constructed at the first time (t=t₀) and placed at a first position (x1, y1), is moved to a third position (x3, y3) via an intermediate position (x2, y2), and is destroyed and disappears at the second time (t=t₁). In this case, the movement may be specified by applying two additional instruction parameters.

A first instruction parameter, i.e., LIFE parameter, may indicate the duration during with the object stays at the first position, a second LIFE parameter may indicate the duration during which the object stays at the intermediate position, and the third LIFE parameter may indicate the duration during which the object stays at the third position. The first to third instruction parameters may enable to deduct the movement of the object #3. Further, the object-based multimedia composition device may calculate the durations during which the object is to be rendered at each location.

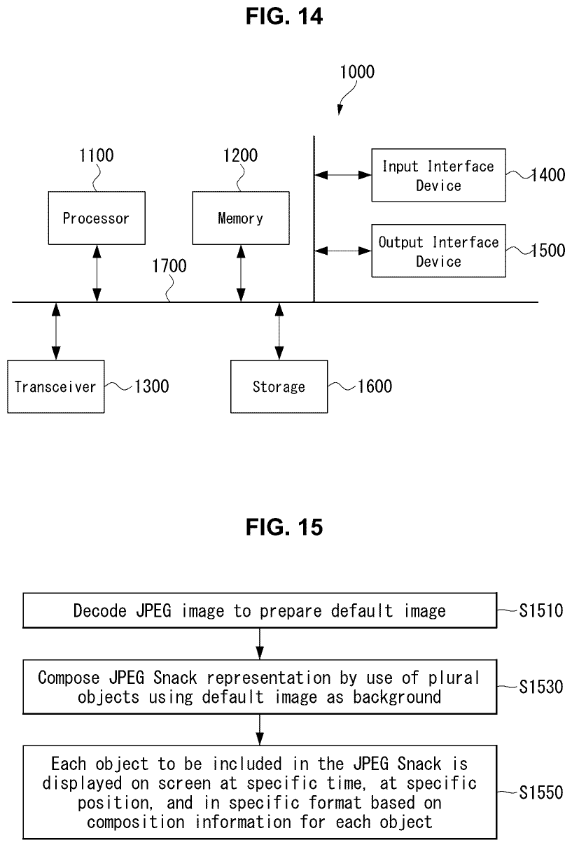

FIG. 14 is a block diagram of an object-based multimedia composition device for a short-form content (hereinbelow, abbreviated as “multimedia composition device”) according to an exemplary embodiment of the present disclosure.

Referring to FIG. 14, the multimedia composition device 1000 may include at least one processor 1100 and a memory 1200. The multimedia composition device 1000 may further include a transceiver 1300 and/or a storage device 1600. Additionally, the multimedia composition device 1000 may further include an input interface device 1400 and/or an output interface device 1500. The components included in the multimedia composition device 1000 may be connected to each other by a bus to communicate with each other.

The processor 1100 may be configured to execute program instructions stored in the memory 1200 and/or the storage 1600 to perform the multimedia composition method according to the present disclosure. The processor 1100 may include a central processing unit (CPU) or a graphics processing unit (GPU), or may be implemented by another kind of dedicated processor suitable for performing the method of the present disclosure.

The memory 1200 may include, for example, a volatile memory such as a read only memory (ROM) and a nonvolatile memory such as a random access memory (RAM). The memory 1200 may load the program instructions stored in the storage 1600 to provide to the processor 1100 so that the processor 1100 may execute the program instructions.

The storage 1600 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

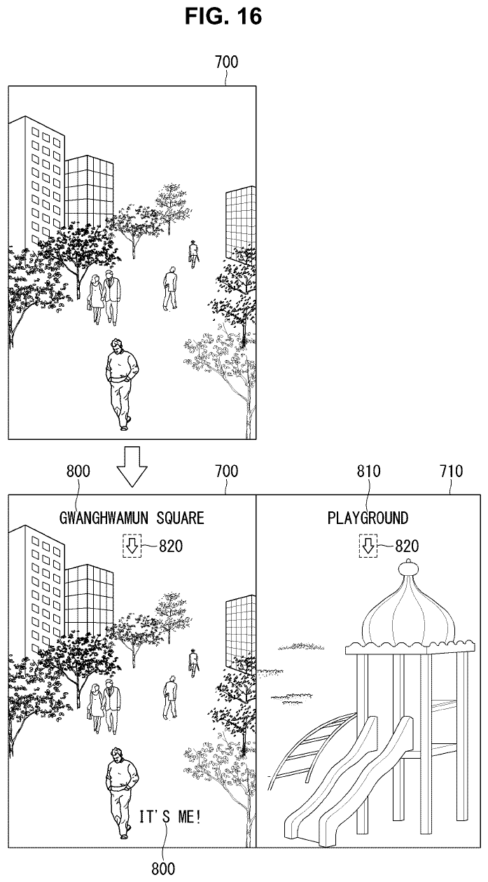

At least one instruction executed by the processor 1100 may include instructions for performing each operation shown in FIG. 1, instructions for performing each operation shown in FIG. 16 described below, and other instructions for performing operations that may be employed in the method of the present embodiment.

FIG. 15 is a flowchart illustrating a multimedia composition method that may be performed by the multimedia composition device of FIG. 14.

Referring to FIG. 15, the multimedia composition method may be performed by a decoder mounted on a processor of the multimedia composition device. The decoder may compose a final representation using the information such as the size and style of the objects specified in the object-structured format based on the object-composition format.

Specifically, the processor performing the operations of the multimedia composition method may prepare or generate the default image by decoding the JPEG image (S1510).

Next, the processor may compose the JPEG Snack representation by use of a plurality of objects that use the default image as the background (S1530).

Afterwards, the processor may handle the JPEG Snack representation so that each object to be included in the JPEG Snack may be displayed appropriately on the screen of the display device for the representation at a specific time, at a specific position, and in a specific format based on the composition information for each object (S1550).

The composition information may include the metadata model comprised of the object-structured format and the object-composition format. The object-structured format may include the first object-structured format and the second object-structured format and the object-composition format may include the first object-composition format and the second object-composition format. The first object-structured format and the first object-composition format may specify or define the first media data, and the second object-structured format and the second object-composition format may specify or define the first media data.

The multimedia composition device enables to provide a JPEG file which may be reproduced in such a manner that a playback time of each image in consecutive images, photo slides, a presentation material, and so on may be adjustable, or an overlapping or overlay image may be chosen and the and the playback time of the overlapping or overlay image may be adjustable.

FIG. 16 illustrates an example of a multimedia content that may be produced by the multimedia composition device of FIG. 14.

In the example of FIG. 16, the multimedia composition device may be configured to insert a subtitle or caption 800 and a cursor 820 into the first image 700 of the representation, and insert another subtitle 810 and a cursor 830 corresponding to the image into the second image 710.

In addition, the multimedia composition device may be configured to reproduce the representation such that the first image 700 and the second image 710 including respective subtitles and cursors may be displayed during respectively given durations.

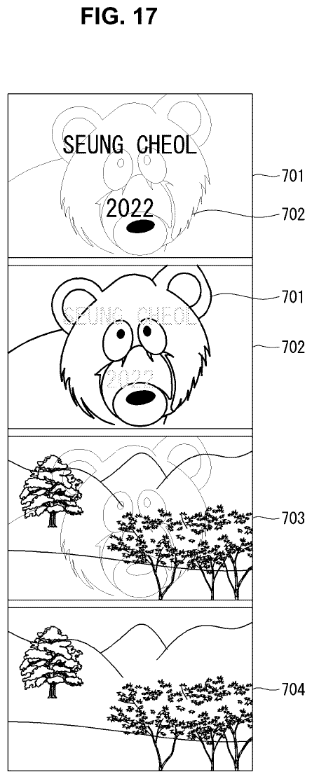

FIG. 17 illustrates another example of a multimedia content that may be produced by the multimedia composition device of FIG. 14.

In the example of FIG. 17, the multimedia composition device may provide a JEPG file in the form of a photo slide including a slide title 701 and three slide images 702-704. Each image in the photo slide may be displayed for a given duration.

For example, the multimedia composition device may display the slide title 701 and the slide images 702-704 in such a manner that the slide title 701 is overlaid on a faded first slide image 702, then the first slide image 702 is faded in while the slide title 701 is faded out in the background, then the second slide image 703 is faded in while the first slide image 702 is faded out in the background, and then the playback of the first slide image 702 is stopped simultaneously with the display of the third image 704, so that the first slide image 702 is not displayed while the third slide image 704 is being played.

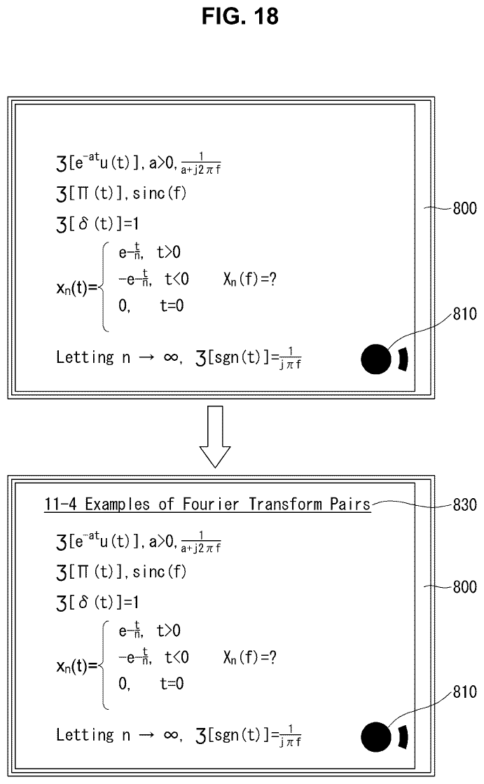

FIG. 18 illustrates another example of a multimedia content that may be produced by the multimedia composition device of FIG. 14.

In the example of FIG. 18, the multimedia composition device may provide presentation materials including audio files and images.

The multimedia composition device may be configured to provide a representation 900 such that a particular image 930 having been chosen in advance may be displayed at a designated location and in a designated size in the representation 900 in synchronicity with the playback of the audio file 910 according to the representation 900.

The device and method according to exemplary embodiments of the present disclosure can be implemented by computer-readable program codes or instructions stored on a computer-readable intangible recording medium. The computer-readable recording medium includes all types of recording device storing data which can be read by a computer system. The computer-readable recording medium may be distributed over computer systems connected through a network so that the computer-readable program or codes may be stored and executed in a distributed manner.

The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the device may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by use of a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. An object-based multimedia composition method performed by a processor, comprising:
specifying a first object-structured format and a first object-composition format of first media data;
specifying a second object-structured format and a second object-composition format of second media data; and
determining a metadata model comprising an object-structured format including the first object-structured format and the second object-structured format and an object-composition format including the first object-composition and the second object-composition,
wherein the object-structured format defines a size, a shape, a movement, an appearance, or a selective combinations thereof of each object including the first media and the second media,
wherein the object-composition format defines appearance or disappearance times of objects composing a representation and temporal and spatial relationships between the objects.

2. The object-based multimedia composition method of claim 1, further comprising:
organizing each object in the metadata model and constituting at least one JPEG Snack file in a predefined container to save structured data as at least one JPEG image file.

3. The object-based multimedia composition method of claim 1, wherein the metadata model is a hierarchical model containing a plurality of object metadata and composition metadata corresponding to the object-composition format and aligned with the plurality of object metadata,
wherein the object metadata corresponding to the object-structured format contains properties comprising position, time, and transition which compose the objects into the representation of a JPEG Snack format,
wherein each of the objects is rendered individually in a logical timeline of a JPEG Snack decoder.

4. The object-based multimedia composition method of claim 3, wherein the object metadata comprises an ID attribute and a Type attribute and specifies behaviors of the objects in the representation constituting a JPEG Snack content,
wherein the ID attribute is an identifier of the object in the representation, and the Type attribute is set to enable a decoder to recognize properties of the object proactively.

5. The object-based multimedia composition method of claim 4, wherein, when the Type attribute is set to indicate an object for a transition between two images, an object compositor controlling a decoding process uses only a transition property of the object metadata.

6. The object-based multimedia composition method of claim 3, wherein the composition metadata allows a display of the objects composing the JPEG Snack representation to be adjusted and enables the objects to be aligned in layer, position, or time based on respective object IDs,
wherein a position property determines a position of an object designated by an object ID,
wherein, when a plurality of objects overlap in the representation, a layer property specifies whether a particular object is positioned in front of or behind remaining objects.

7. The object-based multimedia composition method of claim 3, further comprising:
combining, by the JPEG Snack decoder, time information of all objects in the media data to construct a timeline for reproducing a JPEG Snack content,
wherein the objects exist in the representation using their position and time property information.

8. An object-based multimedia composition method performed by a processor, comprising:
preparing a default image by decoding a JPEG image;
composing a JPEG Snack representation with a plurality of objects using the default image as a background; and
processing each object to be displayed on a screen at a designated time, at a designated location, and in a designated form based on composition information of each object included in a JPEG Snack content;
wherein the composition information comprises a metadata model comprising an object-structured format including a first object-structured format and a second object-structured format and an object-composition format including a first object-composition and a second object-composition,
wherein the first object-structured format and the first object-composition format defines first media data, and the second object-structured format and the second object-composition format defines second media data.

9. The object-based multimedia composition method of claim 8, wherein the metadata model is a hierarchical model containing a plurality of object metadata and composition metadata corresponding to the object-composition format and aligned with the plurality of object metadata,
wherein the object metadata corresponding to the object-structured format contains properties comprising position, time, and transition which compose the objects into the representation of a JPEG Snack format,
wherein each of the objects is rendered individually in a logical timeline of a JPEG Snack decoder.

10. The object-based multimedia composition method of claim 9, wherein the object metadata comprises an ID attribute and a Type attribute and specifies behaviors of the objects in the representation constituting a JPEG Snack content,
wherein the ID attribute is an identifier of the object in the representation, and the Type attribute is set to enable a decoder to recognize properties of the object proactively.

11. The object-based multimedia composition method of claim 10, wherein, when the Type attribute is set to indicate an object for a transition between two images, an object compositor controlling a decoding process uses only a transition property of the object metadata.

12. The object-based multimedia composition method of claim 9, wherein the composition metadata allows a display of the objects composing the JPEG Snack representation to be adjusted and enables the objects to be aligned in layer, position, or time based on respective object IDs,
wherein a position property determines a position of an object designated by an object ID,
wherein, when a plurality of objects overlap in the representation, a layer property specifies whether a particular object is positioned in front of or behind remaining objects.

13. The object-based multimedia composition method of claim 9, further comprising:
combining time information of all objects in the media data to construct a timeline for reproducing a JPEG Snack content,
wherein the objects exist in the representation using their position and time property information.

14. An object-based multimedia composition device, comprising:
a JUMBF parser configured to receive metadata of a JPEG codestream and compose a JPEG Snack representation including an object-structured format and an object-composition format of media data in the JPEG codestream;
a media decoder configured to receive the media data in the JPEG codestream, decode the media data to acquire media content and enable a compositor to render the media content; and
an object composer configured to receive the JPEG Snack representation from the JUMBF parser, provide media format information and time information to the media decoder based on the JPEG Snack representation, and control a decoding operation of the media decoder and an output operation of the compositor such that the media content is output through a display device according to a predetermined time and location for the media content,
wherein the metadata of the media content comprises an object-structured format and an object-composition format to enable a composition of the media content regardless of types of individual media contained in the media content.

15. The object-based multimedia composition device of claim 14, wherein the object-structured format comprises a first object-structured format specifying a size, a shape, a movement, an appearance, or a selective combinations thereof of a first object in the JPEG codestream and a second object-structured format specifying a size, a shape, a movement, an appearance, or a selective combinations thereof of a second object in the JPEG codestream.

16. The object-based multimedia composition device of claim 15, wherein the object-composition format comprises a first object-composition format specifying an appearance or disappearance time of a first object and temporal and spatial relationships between the objects and a second object-composition format specifying an appearance or disappearance time of a second object and temporal and spatial relationships between the objects.

17. The object-based multimedia composition device of claim 16, wherein the metadata model is a hierarchical model containing a plurality of object metadata and composition metadata corresponding to the object-composition format and aligned with the plurality of object metadata,
wherein the object metadata corresponding to the object-structured format contains properties comprising position, time, and transition which compose the objects into the representation of a JPEG Snack format,
wherein each of the objects is rendered individually in a logical timeline of a JPEG Snack decoder.

18. The object-based multimedia composition device of claim 17, wherein the object metadata comprises an ID attribute and a Type attribute and specifies behaviors of the objects in the representation constituting a JPEG Snack content,
wherein the ID attribute is an identifier of the object in the representation, and the Type attribute is set to enable a decoder to recognize properties of the object proactively.

19. The object-based multimedia composition device of claim 17, wherein the composition metadata allows a display of the objects composing the JPEG Snack representation to be adjusted and enables the objects to be aligned in layer, position, or time based on respective object IDs,
wherein a position property determines a position of an object designated by an object ID,
wherein, when a plurality of objects overlap in the representation, a layer property specifies whether a particular object is positioned in front of or behind remaining objects.

20. The object-based multimedia composition device of claim 17, further comprising:
a timeline constructor configured to combine time information of all objects in the media data to construct a timeline for reproducing a JPEG Snack content, or a processor configured to implement the timeline constructor,
wherein the objects exist in the representation using their position and time property information.
